(19) United States
(12) Patent Application Publication
(10) Pub. No.: US 2016/0092580 A1
(43) Pub. Date: Mar. 31, 2016

(54) SYSTEM AND METHOD FOR PROVIDING CONTACT INFORMATION

(71) Applicant: My Office Apps, INC., Tustin, CA (US)

(72) Inventor: Seyed Mehrdad Komeili, Tustin, CA (US)

(21) Appl. No.: 14/500,886

(22) Filed: Sep. 29, 2014

(51) Int. Cl. G06F 17/30; G06Q 10/10

(52) U.S. Cl. CPC G06F 17/30867; G06Q 10/10; G06F 17/30554; G06F 17/30569

(57) ABSTRACT

The invention generally involves a system and method for providing contact information. A system in accordance with the invention may include a database for storing contact information associated with customers. Customers may be assigned unique keywords linked to their accounts, and users of the system may request the customer's contact information by providing the service provider with the customer's unique keyword via requests from a client device. The request includes identifying information, for example metadata associated with both the user and the client device used to send the request. Using this identifying information, the service provider generates a contact record based on the contact information, which may be seamlessly implemented with the contact record repository utilized by the requesting mobile device. Furthermore, the service provider retrieves, from the identifying information, contact information associated with the user of the client device and provides it to the customer.

### TECHNICAL FIELD OF THE INVENTION

The present invention relates generally to a system and method for providing contact information, and more specifically, to a system and method for gathering contact information from a customer and delivering a contact record to a requesting client device in a desirable format, which may be seamlessly implemented with the contact record repository utilized by the requesting client device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

The need for sharing contact information is well known. For example, the practice of exchanging business cards by professionals, business entrepreneurs, and just about anyone wishing to network with others for any purpose, is well established. The exchange of contact information via business cards is quick and easy and achieves the goal of providing others with a desired means to contact an individual or business in a relatively inexpensive means. However, business cards have limitations—they must be carried by individuals or stored in an easily accessible location in order to be available when an opportunity arises for contacting the desired person. One problem is that carrying around too many business cards may be burdensome for many reasons, including the fact that they may be lost or that a user must select which cards to keep on their person at any given time—since typically many business cards are collected over time. Alternatively, storing the cards in a single location, such as a card index means the cards are not easily accessible at any given moment.

Of course, several developments and uses of known technologies have changed the way we store information in a digital era. Mobile devices such as smartphones, tablets, and laptops now have access to applications that store contact information. However, easily gathering this information into a single database and in a desirable format, remains a problem with no adequate solution from the prior art. Users typically have to manually input contact information from their business cards directly on to their devices. This is cumbersome and time consuming. Thus, there is a need for facilitating the sharing and storing of contact information in a manner that streamlines the process for recipients.

The problems described above are obstacles to both recipients of business cards as well as those individuals that distribute them. That is, while a recipient is burdened by having to store each business card physically, or add it to some database manually, a distributer (i.e. an individual wishing to distribute their contact information) is typically burdened by the fact that others may very well lose his or her contact information. For example, an individual may provide her business card to another, and that business card may get lost, or never added to the recipient's contact information list. Thus, there is a need to adequately address the ease with which contact information may be shared and stored in an efficient and reliable manner that provides the distributer of contact information assurances the contact information will be stored by the recipient.

Related to the latter problem is the need for adequately targeting recipients that are in fact interested in the contact information for a source of a product or service. That is, even though business cards or contact information may be typically provided via in-person networking events, recipients are not always interested in receiving the information and instead accept the business card as a matter of politeness. This of course results in the contact information being thrown away or not adequately stored by the recipient. Thus, there is a need to adequately identify interested contact information recipients in order to maximize an effectiveness of the distribution of the contact information.

Yet another problem concerns the distributer of contact information. Often, contact information recipients may not have readily available contact information of their own (i.e. a business card) to provide back to the contact information distributer. That is, those distributing their contact information may very well desire to obtain the contact information of the recipients. Thus, there is a need to provide distributers of contact information with a manner in which to obtain the contact information of recipients.

Therefore, there exists a previously unappreciated need for a system and method for providing contact information that: facilitates the sharing and storing of contact information in a manner that streamlines the process for recipients; adequately addresses the ease with which contact information may be shared and stored in an efficient and reliable means; provides the distributer of contact information assurances the contact information will be stored by the recipient; adequately targets interested contact information recipients in order to maximize an effectiveness of the distribution of the contact information; and provides distributers of contact information with a means in which to obtain the contact information of recipients.

It is to these ends that the present invention has been developed.

### SUMMARY OF THE INVENTION

To minimize the limitations in the prior art, and to minimize other limitations that will be apparent upon reading and understanding the present specification, the present invention describes a system and method for providing contact information, and more specifically, to a system and method for gathering contact information from a customer and delivering that contact information to a requesting client device in a desirable format, which may be seamlessly implemented with the contact record repository utilized by the requesting client device. Furthermore, a contact record or contact information associated with the requesting client device may be simultaneously provided to the customer.

A system for providing user contact information, in accordance with one embodiment of the present invention, comprises: a server including a memory and a database for storing contact information associated with a customer; a network interface coupled to the server; and a processor with access to the memory and database, the processor configured to execute a set of instructions residing in the memory, the set of instructions configured for: receiving from a client device a request for contact information associated with the customer, the request including identifying information; retrieving, from the database, the contact information using the identifying information to match the request to the customer; generating a contact record, formatted for the client device, using the identifying information; and providing the contact record to the client device.

A method for providing user contact information, in accordance with one embodiment of the present invention, comprises: receiving from a client device a request for contact information associated with a customer, the request including identifying information; retrieving, from a database, the contact information using the identifying information to match the request to the customer; generating a contact record, formatted for the client device, using the identifying information; and providing the contact record to the client device.

Another method for providing user contact information, in accordance with one embodiment of the present invention, comprises: providing a user interface configured to receive and store, in a database, contact information associated with a customer; receiving from a client device a request for the contact information associated with the customer, the request including identifying information comprising metadata associated with the client device, and a unique identifier associated with the customer; retrieving from the metadata associated with the client device, user contact information associated with the client device; storing, in a database, the user contact information associated with the client device; retrieving, from the database, the contact information associated with the customer using the identifying information to match the request to the customer; retrieving, from a database, the contact information using the identifying information to match the request to the customer; generating a contact record, formatted for the client device, using the identifying information, including executing a set of formatting instructions to format the contact information according to a format identified using the identifying information; and providing the contact record to the client device.

It is an objective of the present invention to provide a system that facilitates storage of contact information.

It is another objective of the present invention to provide a system that facilitates distribution of contact information.

It is yet another objective of the present invention to provide a system that facilitates proper formatting and consolidation of contact information.

These advantages and features of the present invention are not meant as limiting objectives, but are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. The drawings that accompany the detailed description can be briefly described as follows:

FIG. 1 illustrates the components of a system in accordance with one embodiment of the present invention.

FIG. 2 illustrates an exemplary embodiment of a server for a system in accordance with the present invention.

FIG. 3(a) illustrates an exemplary database, including data repositories, in accordance with one embodiment of the present invention.

FIG. 3(b) illustrates a data repository in accordance with one embodiment of the present invention.

FIG. 4 depicts a flowchart illustrating a method for receiving and storing customer contact information by a server, in accordance with one embodiment of the present invention.

FIG. 5 depicts a flowchart illustrating a method for distributing customer contact information from a server, in accordance with one embodiment of the present invention.

FIG. 6 depicts a flowchart illustrating a method enabling a system in accordance with the present invention, to receive and store customer contact information and distribute the customer contact information to requesting users.

FIG. 7 depicts a flowchart illustrating a method for receiving customer contact information from a client device, in accordance with one embodiment of the present invention.

### DETAILED DESCRIPTION OF THE INVENTION

In the following discussion that addresses a number of embodiments and applications of the present invention, reference is made to the accompanying figures, which form a part thereof. Depictions are made, by way of illustration, of specific embodiments in which the invention may be practiced; however, it is to be understood that other embodiments may be utilized and changes may be made without departing from the scope of the present invention.

Generally, the invention involves a method for gathering contact information from a customer and delivering that contact information to a requesting client device in a desirable format, which may be seamlessly implemented with the contact information format utilized by the requesting client device. For example, a client device may send a request for contact information, which includes metadata associated with the user of the client device, as well as metadata concerning the format of the contact information repository utilized by the client device; thus, from the metadata, a service provider may retrieve the information required to properly format the requested contact information belonging to the customer, and provide a contact record in the appropriate format for implementation into the contact record repository of the client device. In exemplary embodiments, the customer may also obtain contact information from a user of the client device by, for example, obtaining from the metadata contact information that belongs to the user associated with the client device; this type of reverse contact information gathering may be beneficial so that customers providing their contact information may simultaneously gather the contact information of the users making the request via the client device.

In exemplary embodiments, a service provider may obtain contact information from users or customers that subscribe to its service. The service provider may host a user interface designed to receive requests for the service and obtain each customer's contact information for storing at the service provider's database. In exemplary embodiments, the user interface is accessible via known communication networks and customers may subscribe for a variety of plans that ensure their contact information is distributed to targeted users. In exemplary embodiments, the service provider assigns one or more unique keywords associated with the customer, depending on the customer's preferences. These unique keyword(s) may be distributed by the customer, the service provider or a third party, as a means to advertise the customer's services or products. When users see an advertisement or otherwise obtain access to the keyword(s), they may use each keyword to request the customer's contact information. In an exemplary embodiment, the user requests the customer's contact information via a text message.

Users may include friends, colleagues, or persons interested in the services or products offered by the customers. When a user desires to contact the customer, the user sends a request, which contains certain identifying information including the keyword that is associated with the customer. The identifying information may also include metadata that allows the service provider to generate a contact record associated with the customer; the contact record is generated and provided in a format that is suitable for seamless implementation into the requesting client device's contact records. Because the service provider utilizes an executable program to format the contact record according to the format used by the requesting device, the user will not have to manually add the contact record to their contact repository.

For purposes of the present application the term customer means any user that subscribes to the services offered by a service provider using a system or practicing a method in accordance with the present invention. The term user refers to any user of the system and method offered by the service provider, without necessarily having any affiliation or subscription with the service provider. The term client device means any computer device, such as a personal computer, desktop computer, laptop computer, tablet, smartphone, mobile phone, or any other mobile device that can communicate via networks including the Internet and wireless cellular networks. The term advertisement means any informative or otherwise marketing communication used to encourage users to contact a customer or inform users of a means to contact a customer. An advertisement may include a sign, billboard, poster, brochure, flyer, audio announcement, video announcement, electronic announcement, or any other marketing or announcement means. The term identifying information may refer to metadata, or any other identifying information concerning: a user associated with the client device; details regarding the client device itself; information pertaining to the operating system of the client device; information regarding a format of a contact repository utilized by the client device; or any other identifying information pertaining to the client device or the user associated with the client device. The term keyword or unique keyword may refer to any unique identifier such as a numeric identifier, alphanumeric identifier, word or words, terms, symbols or any other identifier that a service provider may provide to a customer and associate with one or more sets of contact information. Furthermore, a unique keyword may be unique to a single customer or unique to a customer in a particular geographic area.

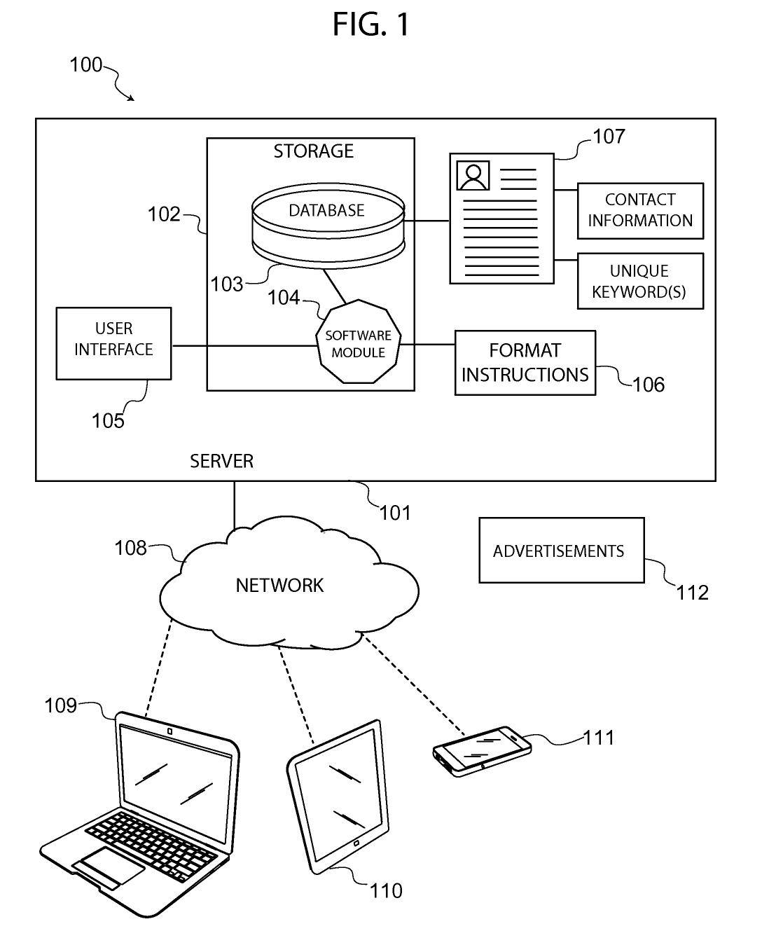

Turning now to the figures, FIG. 1 illustrates the components of a system in accordance with one embodiment of the present invention. More specifically, FIG. 1 shows system 100, including server 101, storage 102, database 103, and software module 104. Software module 104 includes user interface 105 and formatting instructions 106; database 103 includes multiple data repositories, such as data repository 107—data repository 107 typically including customer contact information and one or more unique keywords associated with the customer. Server 101 may be accessed via network 108 by multiple client devices 109, 110 or 111. Additionally, system 100 may include advertisements 112 wherein unique keywords associated with customers are advertised to users of system 100.

Server 101 may be any appropriate server computer, or group of computers, without departing from the scope of the present invention. Server 101 may typically be configured for storing and providing contact information associated with system 100's customers. More specifically, server 101 may be configured to receive requests from a client device of a user of system 100, wherein the requests include identifying information associated with the client device and the customer. Server 101 may further be configured to retrieve the requested information from database 103, generate a contact record, and provide the contact record to the requesting client device of the user. Typically server 101 includes, or has access to, software module 104, which enables server 101 to perform the desired tasks.

In an exemplary embodiment, server 101 is a distributed server system set up for robustness in case one server fails. In another exemplary embodiment, server 101 is a World Wide Web (WWW) server connected to the internet. In other embodiments, server 101 comprises representational state transfer (REST) architecture. Although other architectures may be implemented, a REST server may be desirable to maximize efficiency, particularly in systems that may experience an expanding user profile pool. Furthermore, REST architecture may add an element of security that is well known and suitable for system 100, as server 101 may act as a barrier between the various devices and applications requesting data from database 103. Furthermore, this architecture may provide a centralized means of connecting with other system components such as third-party applications or websites. Naturally, server 101 may comprise of a plurality of distributed servers configured for fault tolerance, duplication and backup capabilities. Moreover, server 101 may be configured with any known techniques and in any known manner to achieve a desired security and functionality.

Storage 102 may be coupled either externally or internally to server 101. Storage 102 is typically one or more long term memory storage devices, such as a hard drive, disk drive, tape unit, Network Attached Storage (NAS) device, Storage Attached Network (SAN) device, RAID disk array, or optical disk array. Although typically a long term memory storage device, storage 102 may be any other memory device without departing from the scope of the present invention. In an exemplary embodiment, storage 102 is striped across redundant storage containers or RAID disk array in a SAN environment for increased data access speeds and robustness. Of course, any other storage configuration would not deviate from the scope of the present invention so long as storage 102 is suitable for the needs of server 101.

Database 103 holds data objects within data repositories collected by system 100, and may be stored on storage 102. Database 103 may be created by a known database manager using known technologies such as relational architecture and SQL access, such as Microsoft™ SQL or Oracle™ DB. However, database 103 may be as simple as a series of files stored in a directory, with a text file listing filename locations without departing from the scope of the present invention. In one embodiment, database 103 is a combination of a known database manager, and an organized directory tree structure, wherein the database manager stores text information in the database itself, but stores multimedia information and other non-text information as filename locations of files stored in an organized directory tree structure.

Database 103 may hold multiple data repositories such as data repository 107. Multiple data repositories, such as data repository 107, correspond to multiple contact records for multiple customers of system 100. Database 103 may be organized around a unique identifier as a database key, one for each data repository 107. Each data repository comprises one or more data objects that form a customer's profile, including the necessary information to create one or more contact records associated with one or more unique keywords, which are in turn associated with each customer of system 100.

Software module 104 may include one or more sets of executable instructions that perform the various tasks of server 101, for example including formatting instructions 106, which may be utilized to generate a contact record suitable for seamless implementation into a contact record repository utilized by a requesting client device. Software module 104 may be typically installed and loaded into storage 102 with access to database 103, for example to utilize data repository 107 in order to generate and provide a contact record. Software module 104 may comprise, without limiting the scope of the present invention: a set of executable instructions for providing a user interface, a set of executable instructions for assigning a UID and data repository to a customer; a set of executable instructions for assigning one or more unique keywords to a customer; a set of executable instructions for receiving and storing contact information from a customer; a set of executable instructions for receiving, from a client device, a requests for contact records of a customer; a set of executable instructions for generating and providing, to a client device, a contact record of a customer; a set of executable instructions for updating data on each customer's data repositories; a set of executable instructions for receiving and storing contact information associated with a requesting client device; and also including formatting instructions 106, which may include a set of executable instructions for generating a contact record suitable for seamless implementation with the contact record repository utilized by the requesting client device. As briefly mentioned, one component of software module 104 may include a user interface, such as user interface 105.

User interface 105 enables bidirectional communication between client devices 109, 110, 111, and server 101 via network 108. That is, user interface 105 is a means for customers to communicate with server 101 and either sign up for services offered via system 100, or update their profiles stored in data repositories such as data repository 107. User interface 105 may be a website hosted by server 101, or a mobile device application distributed to client devices for download from a third party. Typically, user interface 105 comprises client software installed on a remote machine which communicates via a TCP/IP network with server 101. In an exemplary embodiment, user interface 105 may be a website hosted by server 101 communicating through HTTP protocol.

Formatting instructions 106 typically enables system 100 with access to instructions for generating a contact record in the format used by the requesting client device. In one embodiment, formatting instructions 106 may include one or more formatting instructions that correspond to one or more formats desired for generating a contact record. Each known format may require a separate set of instructions in order to generate a format compatible with the format of the targeted recipient client device. Thus, formatting instructions 106 may contain formatting instructions for OSX devices, iOS devices, Window's phone devices, Window's devices, Android devices, Unix-based devices, or any other platform for any other client device suitable for requesting and receiving a contact record. Similarly, formatting instructions 106 may contain formatting instructions for a particular contact records application utilized by any of the above mentioned operating systems. As such, formatting instructions 106 are typically configured to generate a contact record matching the format utilized by a client device's operating system or contact record application. Of course, any other means of providing system 100 with formatting instructions may be implemented, without limiting the scope of the present invention; however, whatever means is used, system 100 is preferably enabled with access to instructions for generating a contact record in the format used by the requesting client device.

Data repository 107 is one of multiple data repositories wherein the data associated with each customer of system 100 is stored. That is, data repository 107 may include a customer profile for storing contact information pertaining to the customer such as: name, last name, business name, personal telephone number, business phone number, facsimile number, email, website address, and any other information that may be provided from the customer to a requesting user in order to contact the customer. Additionally, data repository 107 may include multimedia files that a customer may want to distribute or share via system 100, such as images or videos of themselves or their business. Data repository 107 is associated with a unique identifier belonging to each customer of system 100. Furthermore, data repository 107 may also include one or more keywords that have been assigned to the customer or selected by the customer. The one or more keywords assigned to a customer may be used by system 100 to generate a contact record by, for example, matching the one or more keywords to a user identifier associated with the customer. Once assigned to a customer, keywords are stored in their data repository such as data repository 107. A user desiring a customer's contact information may send a request, including the one or more keywords stored in data repository 107, to server 101 via network 108.

Network 108 may be any type of network, such as a wide area network. A connection with network 108 may be wireless, through a LAN connection, a dial-up connection, or any other method of connecting with network 108 without departing from the scope of the present invention. Typically, network 108 is a wide area network such as the internet, wherein a large number of users may communicate from anywhere in the world. In exemplary embodiments, network 108 links many customers and users via smart device or computers to provide mutual access to multiple internet-based features. Thus, network 108 may provide access to profile information on a website or mobile device application.

As such, server 101 may be accessed via network 108, which communicates server 101 with client devices such as client devices 109, 110, and 111. Via network 108, access may be provided to customers for: signing-up with system 100 services, updating the customer's contact information, managing the customer's assigned keywords or service provider plan, and accessing any other features or services provided to customers via user interface 105 or otherwise. Via network 108, access may be provided to users for: requesting a contact record associated with a customer, and accessing any other features or services provided to users via user interface 105 or otherwise.

As mentioned above, client devices 109, 110, and 111 may be any type of device capable of communicating with server 101 via network 108. Client devices 109, 110, 111 may be utilized by customers and user's alike to, respectively, sign-up for services provided by the service provider or request a contact record from a customer.

As will be explained in more detail below in reference to the remaining figures, when server 101 receives a request for the contact information of a customer, server 101 will retrieve identification information that includes metadata pertaining to the requesting client device's operating system or otherwise pertains to the file types utilized by the contact application of the client device. A set of instructions may be implemented that will take this information in order to generate a contact record suitable for seamless implementation into the contact application of the requesting client device.

For example, and without limiting the scope of the present invention, the following scenario may represent one way in which a customer may subscribe for services via system 100, and one or more users may request be provided with the customer's contact information: a customer may send a request to subscribe to the services of system 100 via client device 109; accessing server 101 via network 108, the customer visits a website belonging to system 100, wherein user interface 105 is provided (e.g. one or more webpages); via user interface 105, customer provides their contact information, including the customer's name, last name, and phone number; the customer may select one or more keywords to be associated with the customer; the customer's information is stored by server 101 into database 103, for example data repository 107; the customer may be provided with an option to advertise their one or more keywords via advertisement 112 (e.g. a billboard), or the customer may utilize a third party to provide advertisement 112. The advertisement may say something like: “for patent application services text ‘Patent Attorney’ to 555-5555”; two user's may see advertisement 112 and desire to contact the customer—one user sends a text message via client device 110, while the other user sends a text message via client device 111. Server 101 receives each request and matches the keyword to identify the customer that has selected the unique keyword ‘Patent Attorney,’ further retrieving the contact information such as the name, last name and phone number provided by the customer; furthermore, server 101 utilizes instructions for generating a contact record in the format used by the requesting client device. For example, software module 104 enable server 101 to execute a program or set of instructions that retrieves relevant metadata from devices 110 and 111. This metadata identifies the correct format for the contact record, and server 101 generates the contact record accordingly. In other words, if client device 110 is an iPad, server 101 will receive (along with the requesting text) identifying information such as metadata that identifies to server 101 that client device 110 is an iPad. Similarly, if client device 111 is an Android device, then the request from client device 111 to server 101 may contain identifying information that identifies to server 101 that client device 111 is an Android device. Accordingly, server 101 generates a contact record formatted for each client device 110 and 111. This provides each user the desirable advantage of receiving the contact information in a format that will seamlessly implement the contact record generated by server 101 into both client devices 110 and 111. The customer will be ensured that their contact information is received by each user and added to that user's contact records, and the user will not have to manually add the customer to their contact application.

Furthermore, as will be discussed below, server 101 may retrieve from the identifying information included in the request from each client device, contact information associated with each client device. For example, and without limiting the scope of the present invention, server 101 may be configured to retrieve information about the client device's user such as name, address, phone number associated with the device, email address, etc. This information may be stored in the database in order for the customer to review the information of those users that have requested a contact record from the customer.

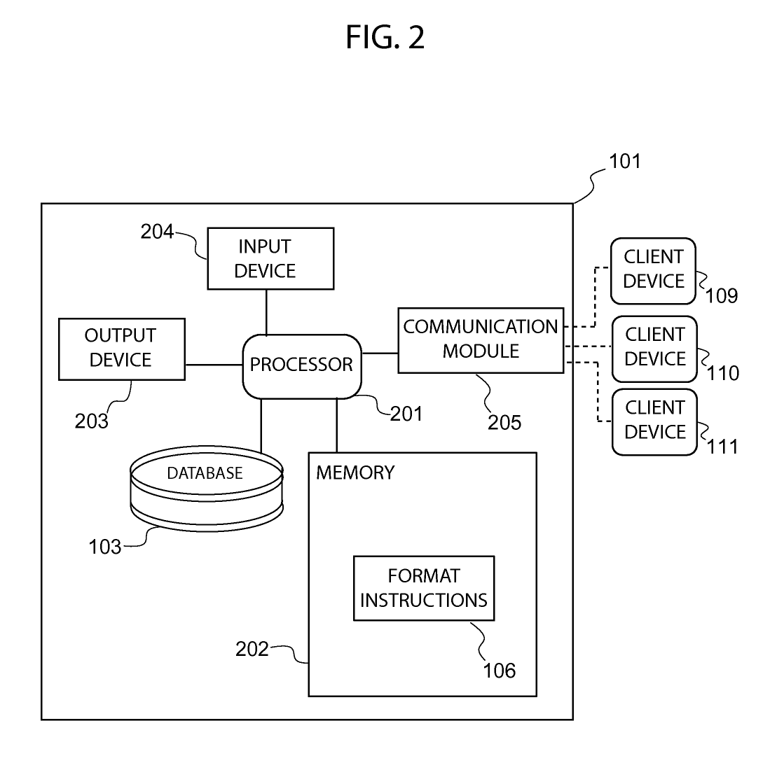

Turning to the next figure, FIG. 2 illustrates an exemplary embodiment of a server for a system in accordance with the present invention. More specifically, server 101 is depicted with the following components: processor 201, memory 202, output device 203, input device 204, and communications module 205. Server 101 is configured to communicate with remote devices such as client device 110 and client device 111, which communicate with server 101 via network 108. Furthermore, server 101 is configured to execute a set of formatting instructions to generate a contact record in accordance with identifying information contained in a request from a client device. Server 101 comprises at least one input device 204, and at least one output device 203, utilized for example to create and or manage a user interface with which a server administrator can load software module 104. Each of the components of server 101 is discussed in turn.

Processor 201 may be any suitable processor or set of processors for carrying out the various functions of server 101. For example and without deviating from the scope of the present invention, processor 201 may be configured to: receive a request for contact information from a client device (e.g. client device 210) via a wireless network utilizing communications module 205; retrieve from the request identifying information concerning the client device; retrieve from the request identifying information concerning one or more keywords associated with a customer; retrieve from database 103 contact information belonging to the customer and associated with the one or more keywords included in the request from the client device; execute software module 104 or a component thereof including a set of formatting instructions 206 to generate a contact record according to the identifying information concerning the client device; and provide the client device with the contact record by delivering the contact record to the client device via network 108 utilizing communications module 205.

Memory 202 may be on a logically or physically separate disk than storage 102, attached locally to server 101 or remotely through another means, without departing from the scope of the present invention. In another embodiment, both database 103 and software module 104 reside on the same storage. Typically, memory 202 has access to formatting instructions 206 for processor 201 to execute.

Communication module 205 is typically an internal network jack built into server 101's motherboard but can likewise be a network card, a modem, a Bluetooth device, or any other device which allows bi-directional communication with another hardware device without departing from the scope of the present invention.

The major software modules for system 100 are typically installed and loaded into memory 202 accessible to server 101. These modules comprise formatting instructions 206, which may be one or more set of executable instructions that enable server 101 to generate contact records in a format that may be seamlessly implemented with the contact application utilized by the requesting client device.

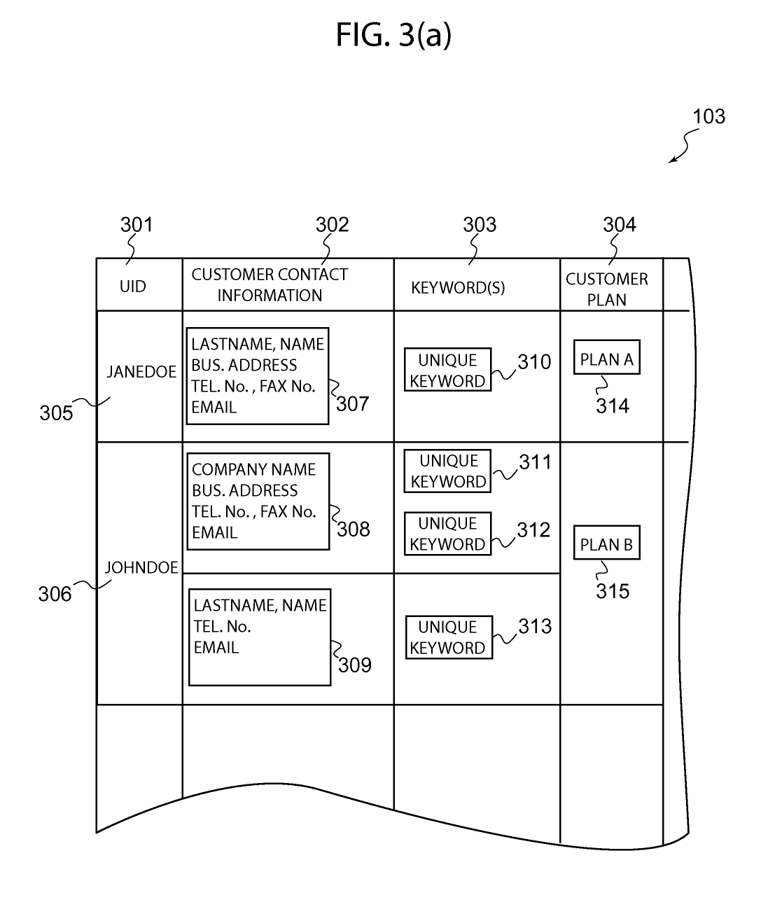

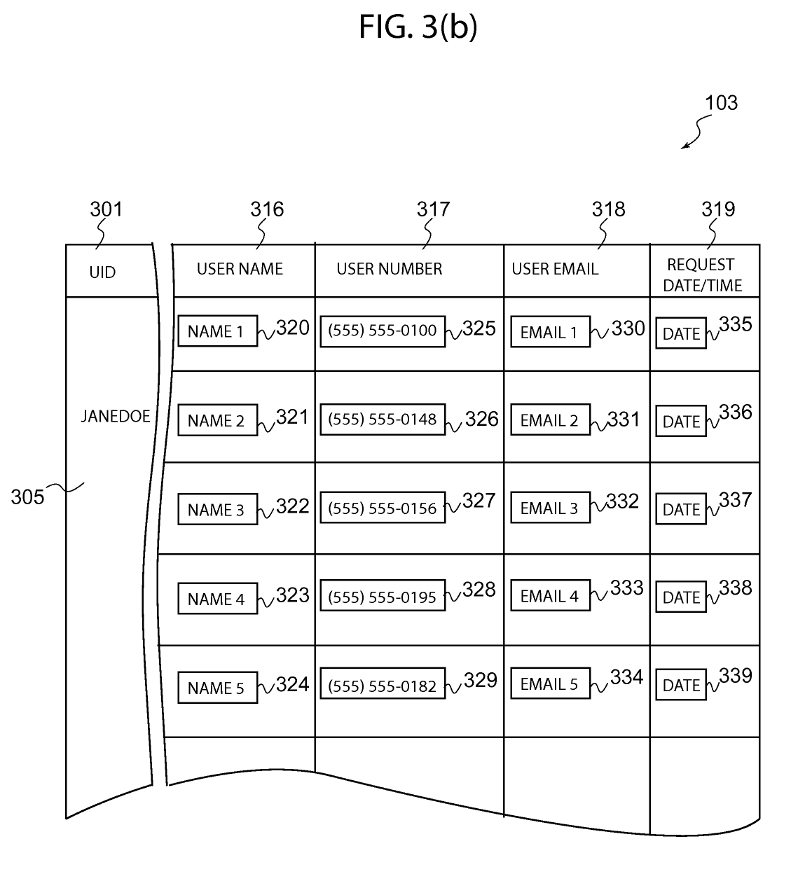

Turning now to the next figure, FIG. 3(a) illustrates an exemplary database in accordance with one embodiment of the present invention. More specifically, FIG. 3(a) illustrates an embodiment of a database in accordance with the present invention with data object types 301-304, data repositories 305-306, and data objects 307-315. To illustrate one possible configuration of a database in accordance with the present invention, each of the depicted columns corresponds to a different data object type 301, 302, 303, and 304 that can be stored in a data repository such as data repository 305 or 306. Each of the depicted rows corresponds to a different data repository 305 and 306, which in turn corresponds to a different customer profile stored in the database. Data object type 301 refers to unique identifiers, which are used as a key to uniquely identify each data repository. Data object type 302 corresponds to customer contact information, so that any data objects stored under this data object type concerns one or more sets of contact information that a customer may desire to distribute to users. Data object type 303 corresponds to unique keywords that customer may select or be assigned. Data object type 304 corresponds to a customer plan that may be offered to a customer by the service provider.

A customer's data repository contains at least one data object, one of which is identified as customer's data object 307, another that is identified as customer's data object 308, and yet another that is identified as customer's data object 309, these and other data objects may make up the contact information each customer of system 100 inputs into in database 103 and intends to present to prospective users.

To further illustrate an example in accordance with the present invention, a customer may contact system 100 via user interface 105 and subscribe to their service. That is the customer may contact the service provider via a website or via a downloadable app on their remote device. The customer may be guided with user interface 105 to input their contact information. Upon subscription, the customer is issued a UID—for example, a customer named Jane Doe may subscribe to system 100's service and be issued the username JANEDOE, which will be associated with data repository 305 and assigned for that customer's use. Similarly, a customer named John Doe may subscribe to system 100's service and be issued the username JOHNDOE, which will be associated with data repository 306 for that customer.

Each data repository 305 and 306 will be used to store each customer's contact information as data objects. Thus, data object 307 may include JANEDOE's contact information such as name, last name, business address, telephone number, facsimile number, and email address. Furthermore, each data repository 305 and 306 may be used to store other data objects such as data objects 310 or 311, which include one or more unique keywords or terms that may be unique to each data repository, depending on the type of subscription offered and selected by a customer. For example, and without deviating from the scope of the present invention, customer JANEDOE may be provide server 101 with her contact information, which is stored and may be viewed as data object 307. The service provider may further assign, or JANEDOE may select, one or more unique keywords that JANEDOE would like to use in her advertisements or to provide prospective users in order to obtain her contact record. In the instance illustrated, JANEDOE has selected a single word that is associated with JANEDOE and stored in data repository 305 as data object 310. Similarly, the customer who has been assigned username JOHNDOE may be provided with data repository 306, wherein JOHNDOE's contact information may also be stored. However, JOHNDOE may have one or more businesses or purposes for providing different contact information, as such, data repository 306 may include more than a single data object for his contact information, such as data objects 308 and 309. Data object 308 may pertain to his business contact information, while data object 309 may pertain to his personal contact information. Additionally, different unique keywords may be selected by JOHNDOE and thus repository 306 may include data objects 311, 312, and 313 for each selected keyword. That is, while JOHNDOE may wish to utilize two unique keywords to target potential users to his business, JOHNDOE may only select a single unique keyword for his personal information.

In exemplary embodiments of the present invention customers may be provided with different plans wherein multiple types of options with unique keywords may be provided. For example, and without limiting or deviating from the scope of the present invention, some plans may include: exclusive utilization of a unique keyword; exclusive utilization for a unique keyword for one or more geographic regions; exclusive utilization of multiple words; and/or exclusive utilization of multiple unique keywords for one or more geographic regions. As is illustrated in FIG. 3(a), the customer associated with data repository 305 has selected PLAN A, represented by data object 314, while the customer associated with data repository 306 has selected PLAN B, represented by data object 314. As depicted, PLAN B may include multiple unique keywords; each represented by data objects 311, 312, and 313.

When a user sends a request from their client device for the customer associated with data repository 306, JOHNDOE, server 101 will use or retrieve identifying information on the user's request to generate a contact record. In the illustrated example of FIG. 3(a), if the request includes identifying information comprising data object 311 (i.e. or an equivalent identifier thereof), or data object 311 (i.e. or an equivalent identifier thereof), then server 101 will generate a contact record including data object 308. Alternatively, if the request includes identifying information comprising data object 313 (i.e. or an equivalent identifier thereof), then server 101 will generate a contact record including data object 309. In other words, a customer may select what information is provided in the contact record to user-requesters utilizing different unique keywords. Of course, server 101 will also utilize or retrieve from the identifying information metadata pertaining to the contact format utilized by the requesting client device from which the user has sent his or her request. Server 101 may use this contact format to execute formatting instructions that generate a contact record in a format compatible with the contact application utilized by the requesting client device.

Turning now to FIG. 3(b), a data repository in accordance with one embodiment of the present invention is illustrated. Specifically, a portion of data repository 305 belonging to JANEDOE is shown comprising additional data object types 316-317, and including several data objects 320-339 that have been stored therein. In this exemplary embodiment of a data repository, user contact information that has been gathered in a reverse contact information gathering process is also stored in a customer's data repository, such as data repository 305.

For example, and without deviating from the scope of the present invention, every time a user makes a request for contact information associated with a customer, the system may retrieve certain user information from the request itself. In FIG. 3(b), we can see one example of how this information may be stored for a customer to later utilize. Of course, any other organizational scheme may be implemented, and the information may be stored in any known means. As an example however, data object types 316-319 may include user name, user number, user email, and a date and time of the user request, respectively. Thus, in one embodiment, every time a user makes a request for the contact information of a customer, the customer may obtain the user's contact information and have it stored in their data repository.

In the shown embodiment, for example, data repository 305 belonging to the customer JANEDOE has received multiple requests for her contact information from various users. The user's names may be stored as data objects 320-324 under data object type 316. Under data object type 317, each requesting user's telephone number associated with the number of the client device the user initiated the request from is also stored. In the present case, numbers 325-329 have been stored accordingly. Similarly emails may be stored as data objects 330-334, under data object type 318. Furthermore, every time entry that a request from a user is made may be stored as well. As mentioned above, many other organizational means may be implemented without deviating from the scope of the present invention, and this is merely an example for illustrative purposes.

As mentioned above, a means for providing a customer with a requesting user's contact information may be desirable. When stored as illustrated by FIG. 3(b), the information may be utilized by the customer, to for example provide the user's with additional advertising content. This advertising content may include emails, phone calls, newsletters, brochures, electronic communications, or any other information that the customer may want to provide users that have requested their contact information via the service provider.

In exemplary embodiments, this information may be gathered during the receiving process of each user request via a client device. That is, a client device may send a request for contact information, which includes identifying information such as metadata associated with the user of the client device, as well as metadata concerning the format of the contact information repository utilized by the client device. While a service provider may retrieve the information required to properly format the requested contact information belonging to the customer utilizing the metadata, and the service provider may also obtain contact information from a user of the client device by, for example, obtaining from the metadata the contact information that belongs to the user associated with the client device. As mentioned above, this type of reverse contact information gathering may be beneficial so that customers providing their contact information may simultaneously gather the contact information of the users making the request via the client device.

Of course, sharing of the user data may be manipulated or controlled in any known means without deviating from the scope of the present invention. For example, a customer may create email lists to be distributed to the contacts gathered in their data repository. Similarly, these emails may include opt-out provisions so that the users may stop receiving emails. Again, any other type of known information sharing techniques may be implemented in accordance with the present invention.

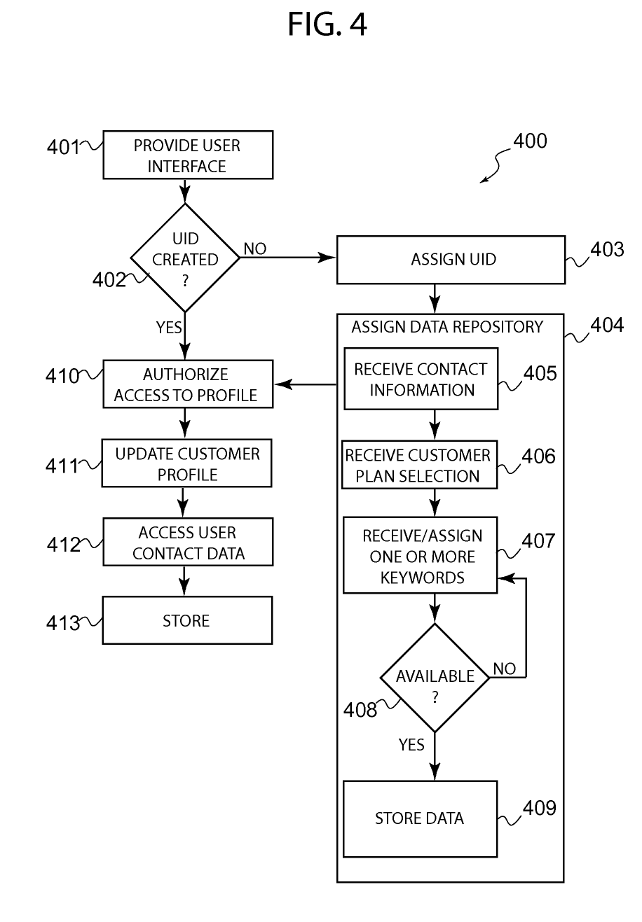

Turning next to FIG. 4, a flowchart illustrates a method for receiving and storing customer contact information, in accordance with one embodiment of the present invention. More specifically, the flow chart focuses on the steps the server takes to allow customers to input data and access data in the database; method 400 may be performed by server 101 in order to store contact information associated with a customer. In the illustrated embodiment, the steps may be followed in the sequence shown, but the following steps may also be taken in a different sequence in order to achieve said task without departing from the scope of the present invention.

In step 400 the server provides a user interface for a customer. A user interface may comprise one or more computers, gadgets, appliances, machines, mobile communication devices, software applications, or websites. The user interface can comprise any method of enabling bidirectional communication with a user without departing from the scope of the present invention. In one embodiment, the user interface is a mobile device application downloadable from a third-party host, such as the App Store®. In another embodiment, the user interface is a World Wide Web website hosted by the service provider, for example server 101. Customers may access the user interface to subscribe and manage their contact information that will be provided to users via practice of the present invention.

In step 402 a determination may be made whether a customer has been assigned a UID or whether the customer is a new customer and requires assignment of a UID and data repository in which to store the customer's contact information. If a customer is an existing subscriber, then an authorization to access their data may be performed in step 405; otherwise, a UID may be assigned in step 403.

In step 403 a UID is assigned to new customers or subscribers of the service provider. For example, and without limiting the scope of the present invention, if the customer has not previously obtained a unique identifier and key, the server may provide a username and password to be later entered as part of a log-on process. The unique identifier and key can be any other type of security interface that limits access to the database provided by the server without departing from the scope of the present invention. Additionally, any other well known method of authentication may be provided without deviating from the scope of the preset invention.

In step 404, a data repository may be created and assigned to the subscribing customer, typically once a UID has been assigned. Accordingly, a request for customer information may be initiated via the user interface in order to populate the data objects in the customer data repository (i.e. create a customer profile).

In step 405, the server may receive contact information pertaining to a customer via the user interface. For example, and without limiting the scope of the present invention, contact information may include name, last name, personal address, business address, primary phone number, secondary phone numbers, facsimile numbers, emails, and any other information that will facilitate contacting the customer. With quick reference to FIG. 3(a), in step 405 the data object 307 may be generated in response to input from the customer assigned username JANEDOE and associated with data repository 305.

In step 406, the server may receive a customer plan selection, which may include without limitation, any subscription plan that may be made available to a customer. For example, and without limiting the scope of the present invention, a plan may include assigning a single unique keyword to a single account; multiple unique keywords to a single account; multiple unique keywords to a single set of contact information; multiple unique keywords to multiple sets of contact information; or any other conceivable plan of subscription that may be offered to a customer, in accordance with the present invention. With quick reference to FIG. 3(a), in step 406 the customer assigned username JANEDOE and associated with data repository 305 has selected a plan allotting a single unique keyword, while the customer assigned username JOHNDOE and associated with data repository 306 has selected a plan allotting multiple unique keywords. Accordingly, data objects 314 and 315 have been stored, respectively in each data repository.

In step 407, the server may receive one or more unique keywords that the customer would like to assign to their contact information. The one or more unique keywords may be one or more words or terms selected by the customer or suggested by the service provider. In one embodiment the unique keywords may be suggested to a customer from a list of available words or terms. In another embodiment, the unique keywords may be selected by the user and thereafter checked for availability by the server. For example, and without limiting the scope of the present invention, a customer may have a business pertaining to consulting services; as such, that customer may desire to use the word ‘consultant.’ Thus, in step 407 the user interface may provide a field for the customer to suggest or search for the unique keyword ‘consultant.’

In step 408, the server may, after receiving input indicating the customer is selecting one or more words, make a determination whether the one or more words are available. The determination of the availability of the word may depend on geographic location or on whether another customer has been assigned exclusive use of that particular word or term. Alternatively, the availability rules for any given unique keyword may be, without limitation, any rules determined by the service provider to be suitable for providing some exclusivity to customers over the chosen unique keywords. If the unique keyword is not available for selection, the server may continue to prompt for or receive a new request for a unique keyword. For example, in some embodiments a user interface may simply provide a drop-down menu where the customer may search for the availability of the term. Of course, any well known means of selecting available words, terms, or identifiers may be utilized without deviating from the scope of the present invention.

Accordingly, in step 409, once it is determined that a unique keyword is available, a data object concerning the selected unique keyword may be stored in the data repository and assigned to the customer with unlimited or limited exclusivity. With quick reference to FIG. 3(a), in step 409 data objects 311, 312, and 313 may be generated in response to input from the customer assigned username JOHNDOE and associated with data repository 306. In this instance, the customer has already provided their contact information and has chosen three unique keywords—two unique keywords are available, stored as data objects 311 and 312, and assigned to data repository 306 in connection with contact information 308; furthermore another unique keyword is available, stored as data object 313 and also assigned to data repository 306 however in connection with contact information 309.

In step 410, where a data repository has been created or assigned to a customer, authorized access to a customer profile may be granted. Accordingly, in step 411, a customer may be update any information previously provided to the server.

In step 412, a customer may access any user contact information that has been gathered by the service provider from each request. For example, user contact information gathered from a request such as phone number, name, email, and time and date of the request may be stored in the database as illustrated by FIG. 3(b). In this step, a customer may access this information and may be provided with any number of known services for distributing information such as marketing materials to each if the users that the customer has received requests from. In step 413, any new information, including settings or preferences selected by the customer may be stored in the database.

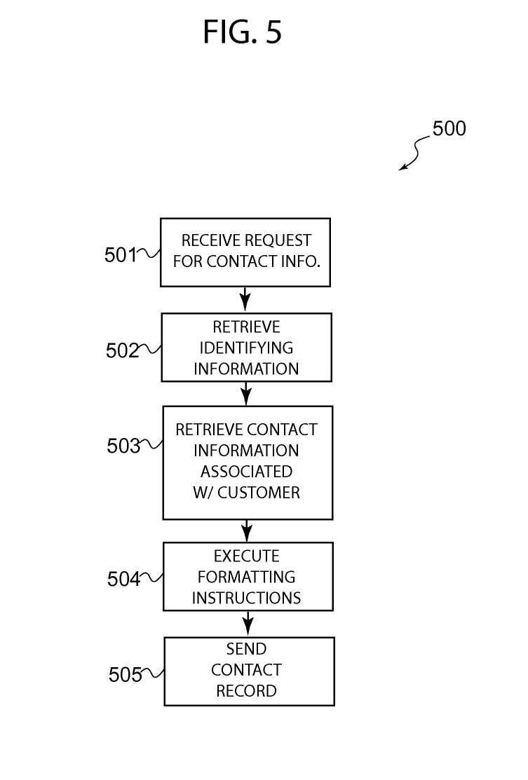

FIG. 5 depicts a flowchart illustrating a method for distributing customer contact information, in accordance with one embodiment of the present invention. More specifically, the flow chart focuses on the steps the server takes to provide users with a contact record associated with a customer; method 500 may be performed by server 101 in order to generate a contact record and provide contact information associated with a customer. In the illustrated embodiment, the steps may be followed in the sequence shown, but the following steps may also be taken in a different sequence in order to achieve said task without departing from the scope of the present invention.

In step 501 the server may receive a request from a user. The request may be in the form of a text message, such as using a short message service (SMS) or a multimedia message service (MMS), an email message, a voice message, any electronic message or request, including a request initiated via universal products code (UPC) or barcode generator, or any other type of request without deviating from the scope of the present intention. Typically, each request is received via a wireless network utilizing a communications module or network interface to communicate with the server. A request may include identifying information pertaining to the client device that is sending the request, as well as identifying information pertaining to the customer, for whom the user is requesting the contact information.

Identifying information may include metadata that aids the server in identifying a format suitable for implementing contact information into the contact application or contact record repository utilized by the client device. For example, and without limiting the scope of the present invention, the metadata may comprise of data identifying the operating system of the client device; data identifying the contact application utilized by the client device; user contact information of a user associated with the client device; details regarding the client device itself; information regarding a format of a contact repository utilized by the client device; or any other information pertaining to the client device or the user associated with the client device. Furthermore, metadata may include any other data that may serve as an identifier for the server to properly generate the requested contact information into a suitable contact record for seamless implementation into the contact repository of the client device. Identifying information may further include one or more unique keywords associated with a customer of the service provider to enable the server to retrieve the contact information associated with the intended customer. Moreover, as mentioned above, identifying information may also include user contact information that the server may store for the customer's use.

Accordingly, in step 502 the server retrieves the identifying information from the request. This step may include retrieving, from the request, identifying information concerning the client device such as the above mentioned metadata or any other information suitable for identifying the format of the contact information of the client device. This step may also include retrieving, from the request, one or more unique keywords associated with the intended customer. As mentioned above, since each unique keyword is typically associated with a single customer, the server will identify the unique keyword and retrieve the contact information pertaining to that customer.

In exemplary embodiments, only a single keyword may be retrieved from a request, thus each request may include a single unique keyword that identifies a single customer. This may be desirable to facilitate the formatting instructions in recognizing the keyword being sent to identify the correct customer. Of course, other variations may be implemented without deviating from the scope of the present invention in which more than a single keyword is included in a request. Typically however, a single request will include a single keyword, whether the single keyword includes one or more terms.

In step 503, the server retrieves form the database the contact information belonging to the customer associated with the identifying information included in the request from the client device. For example, with quick reference to FIG. 3(a), in step 503 the server may retrieve from a request one or more words or terms matching data object 311, which is associated with data repository 306. In this instance, since data object 311 pertains to a unique keyword a customer has associated with data object 308, any contact information included in data object 308 may be retrieved by the server in step 503. The server will utilize this information in generating a contact record as will be further explained below. Furthermore, the server may also retrieve from the identifying information, user data or contact information associated with a user of the client device. For example, with quick reference to FIG. 3(b), in step 503 the server may retrieve from a request identifying information from which the server can generate data objects 323,328, 333, and 338—all pertaining to a set of contact information for the user initiating the request. That is, from the identifying information, the server may retrieve and store in database 103, the name, phone number, email address, and date/time of the user that initiated the request via the requesting client device. This information will be useful for the customer (i.e. in this example, JANEDOE) to glean at a later time, to respond with marketing materials or newsletter, or simply to have that user's contact information for future reference.

In step 504 a set of formatting instructions is executed to generate a contact record. For example and without deviating from the scope of the present invention, the server may execute one or more components of the software module or a component thereof including a set of formatting instructions to generate a contact record according to the identifying information concerning the client device. This may include formatting the contact information in a format compatible for seamless implementation into the contact information application utilized by the requesting client device. For example, formatting instructions may format the contact information into a contact record suitable for implementation into a Unix-based device, such as an iPhone, a Window's phone, an Android phone, an OSX desktop or laptop, a Window's-based personal computer, or for implementation into any other suitable format that matches the format of the requesting device.

In step 505, the server may send or provide the client device with the contact record. Typically, the server utilizes the same network in which it received the request from the client device, however in alternative embodiments different communication means may be set up to send and receive communications. For example, and without limiting the scope of the present invention, the server may receive a request from a client device via a cellular network, and may provide the contact record via a wireless web network. In an exemplary embodiment, the server utilizes a wireless network to receive requests from a client device and provide a contact record in accordance with the requested contact information.

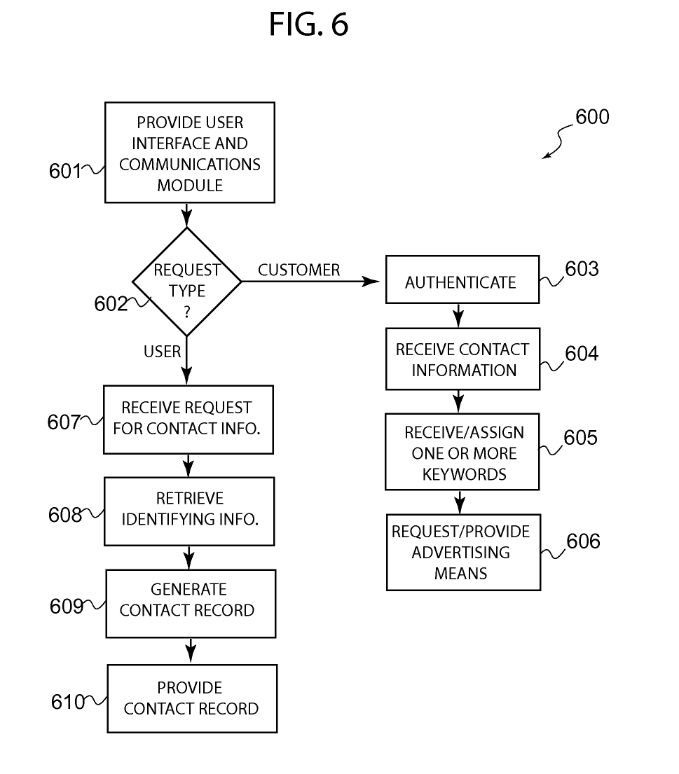

Moving on to the next figure, FIG. 6 depicts a flowchart illustrating a method enabling a system, in accordance with the present invention, to receive and store customer contact information and distribute the customer contact information to requesting users. More specifically, FIG. 6 shows method 600, practiced by a system in accordance with one embodiment of the present invention. In the illustrated embodiment, the steps may be followed in the sequence shown, but the following steps may also be taken in a different sequence in order to achieve said task without departing from the scope of the present invention.

In step 601 a system in accordance with the present invention may provide a user interface. As mentioned above, the user interface may be a website or a software application, for example a mobile app, in order to enable customers to subscribe to the system's service. Furthermore, in step 601 a communications module is provided to enable the system to receive requests from users that request contact information belonging to one or more customers of the system.

In step 602 a determination may be made pertaining to the type of request the system may receive. If the request is a request from customer, then steps 603-606 may follow; if the request is from a user, then steps 607-610 may follow instead.

In step 603, a request for access to a customer profile is received. Known means may be implemented in order to verify and authenticate a customer access. If a customer is a new customer, similar procedures as explained with reference to FIG. 4 may be implemented in order to, for example, assign a UID and assign a data repository for the customer's use.

In step 604, contact information belonging to a customer may be received via the provided user interface. As explained above, this may include one or more sets of contact information belonging to a customer or customer's business.

In step 605 a selection of one or more words, terms or unique keywords is selected by the customer and/or verified by the system. That is, a customer may select, or the system may provide one or more unique keywords for unlimited or limited exclusive use by the customer. In step 607, the service provider may receive a request to provide an advertisement. The advertisement may comprise a billboard, a document, a TV commercial, a radio commercial, or any other type of advertisement in which the customer may advertise their unique keywords to potential users. In one embodiment, a service provider may provide the advertisement directly. In another embodiment, the serviced provider may contract with a third-party for providing the advertisement. In yet another embodiment, the service provider may simply recommend a third-party for providing the advertisement. And in still another embodiment, the service provider may not provide the service at all; hence, it may be left up to the customers to provide their own advertisement for their unique keywords.

As mentioned above, if the request is a user request, then steps 607-610 may follow. In step 607, a request may be received via a server of the system configured to receive requests from client devices via, for example, a wireless network. In step 608 identifying information is retrieved from the request, such as unique keywords associated with the customer for which contact information is being requested, and metadata that aids the system in identifying what format will be suitable for seamless implementation with the contacts stored or accessed by the client device. In step 609, the identifying information may be utilized to generate a contact record using the customer contact information stored in the database of the system. In step 610, the generated contact record may be provided to the client device.

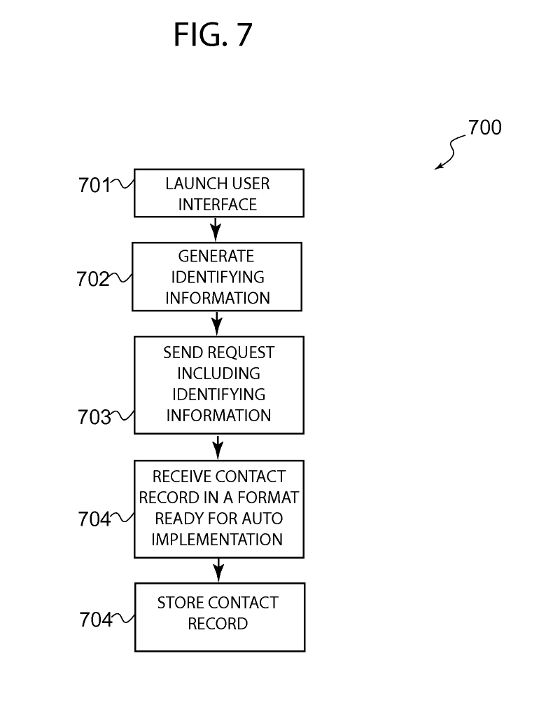

Turning now to FIG. 7, a flowchart is depicted, illustrating a method for receiving customer contact information from a client device, in accordance with one embodiment of the present invention. More specifically, FIG. 7 shows method 700, performed by a client device in accordance with one embodiment of the present invention. In the illustrated embodiment, the steps may be followed in the sequence shown, but the following steps may also be taken in a different sequence in order to achieve said task without departing from the scope of the present invention.

In step 701 a user interface may be provided. A user interface may include text-messaging software or messaging application utilized by the client device, a mobile app downloaded from a third-party, or any other software that enables the client device to send messages. Alternatively, the user interface may be any other type of interface that enables the client device to send a request to a server for the contact information of a customer.

In step 702, an identifying information is generated, embedded or implemented into the message or request. The identifying information may include text input from the user such as one or more unique keywords associated with the customer for whom the user is requesting contact information. Furthermore, identifying information may include any information pertaining to the operating system utilized by the client device, or any information pertaining to a contact records application utilized by the client device. This identifying information may be useful to a server receiving the request, in order to generate a contact record formatted in a way that is compatible with the contact records used or stored by the client device.

In step 703, the identifying information is sent as part of a request for the contact information belonging to a customer of the service provider.

In step 704, a contact record is received in a format ready for seamless implementation into the client device. That is, the client device may receive a text message, such as an SMS message, an MMS message, an email, or any other type of message that may include a contact record. Furthermore, because the message includes a contact record that is formatted in accordance with the format used by the client device to view and/or store contact records, the record may seamlessly be integrated into the contact record repository utilized by the client device.

In step 705, the contact record may be stored. This may mean the contact record is stored locally or remotely without deviating from the scope of the present invention. Typically, since a client device may sync with other devices owned or operated by the same user, the contact record will remain in all of the user's devices. This creates assurances for the customer that the user will retain the customer's contact record. Furthermore, the user will not have to manually add each element of the customer's contact information into their contact records repository.

A system and method for gathering contact information has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A system for providing user contact information, comprising:
a server including a memory and a database for storing contact information associated with a customer;
a network interface coupled to the server; and
a processor with access to the memory and database, the processor configured to execute a set of instructions residing in the memory, the set of instructions configured for:
receiving from a client device a request for contact information associated with the customer, the request comprising identifying information including metadata associated with the client device;
retrieving, from the database, the contact information using the identifying information to match the request to the customer;
generating a contact record formatted for the client device by executing a set of formatting instructions to format the contact information according to a format identified using the metadata associated with the client device; and
providing the contact record to the client device.

2. (canceled)

3. (canceled)

4. The system of claim 1, wherein the set of instructions are further configured for:
retrieving from the metadata associated with the client device, user contact information associated with the client device; and
storing, in the database, the user contact information associated with the client device.

5. The system of claim 1, wherein the metadata associated with the client device includes information pertaining to the operating system of the client device.

6. The system of claim 1, wherein the metadata associated with the client device includes information pertaining to a format for a contacts record repository utilized by the client device.

7. The system of claim 1, wherein the identifying information included in the request comprises a unique identifier associated with the customer.

8. The system of claim 7, wherein the unique identifier associated with the customer includes one or more unique keywords.

9. The system of claim 1, further comprising a user interface configured to receive and store, in the database, the contact information associated with the customer.

10. The system of claim 9, wherein the user interface comprises a website accessible via the network interface.

11. A method performed by a server configured for providing user contact information, comprising:
receiving from a client device a request for contact information associated with a customer, the request comprising identifying information including metadata associated with the client device;
retrieving, from a database, the contact information using the identifying information to match the request to the customer;
generating a contact record formatted for the client device by executing a set of formatting instructions to format the contact information according to a format identified using the metadata associated with the client device; and
providing the contact record to the client device.

12. The method of claim 11, further comprising:
providing a user interface configured to receive and store, in the database, the contact information associated with the customer.

13. (canceled)

14. (canceled)

15. The method of claim 11, further comprising:
retrieving from the metadata associated with the client device, user contact information associated with the client device; and
storing, in the database, the user contact information associated with the client device.

16. The method of claim 11, wherein the metadata associated with the client device includes information pertaining to a format for a contacts record repository utilized by the client device.

17. The method of claim 11, wherein the identifying information included in the request comprises a unique identifier associated with the customer.

18. The method of claim 17, wherein the unique identifier associated with the customer includes a unique keyword.

19. The method of claim 12, wherein:
providing a user interface configured to receive and store, in the database, the contact information associated with the customer includes providing a website.

20. A method performed by a server configured for providing user contact information, comprising:
providing a user interface configured to receive and store, in a database, contact information associated with a customer;
receiving from a client device a request for the contact information associated with the customer, the request including identifying information comprising metadata associated with the client device, and a unique identifier associated with the customer;
retrieving from the metadata associated with the client device, user contact information associated with the client device;
storing, in a database, the user contact information associated with the client device;
retrieving, from the database, the contact information associated with the customer using the identifying information to match the request to the customer;
generating a contact record, formatted for the client device, using the identifying information, including executing a set of formatting instructions to format the contact information according to a format identified using the identifying information; and
providing the contact record to the client device.

21. The method of claim 20, further comprising:
retrieving, from the metadata associated with the client device, information pertaining to the operating system of the client device.

22. The method of claim 20, further comprising:
retrieving, from the metadata associated with the client device, information pertaining to a format for a contacts record repository utilized by the client device.

23. The method of claim 20, wherein the identifying information included in the request further comprises a unique identifier associated with the customer.

24. The method of claim 23, wherein the unique identifier associated with the customer includes a unique keyword.
